(19) United States
(12) Patent Application Publication
(10) Pub. No.: US 2006/0286520 A1
(43) Pub. Date: Dec. 21, 2006

(54) PSYCHOLOGICAL TEST ADMINISTRATION METHOD AND SYSTEM

(76) Inventor: Leon Rosenberg, Cherry Hill, NJ (US)

Correspondence Address: COZEN O'CONNOR, P.C., 1900 MARKET STREET, PHILADELPHIA, PA, 19103-3508, US

(21) Appl. No.: 11/421,617

(22) Filed: Jun. 1, 2006

Related U.S. Application Data
(60) Provisional application No. 60/686,146, filed on Jun. 1, 2005.

(51) Int. Cl. G09B 19/00

(52) U.S. Cl. 434/236

(57) ABSTRACT

A method for improving the accuracy of administration of a psychological test by a human rater comprising providing a computer which is programmed to ask a test question, receive an answer from the human rater, and not go on to ask the next question unless and until the rater accurately answers a confirmation question which is designed to insure that the answer to the last question was correct. Computer code and a programmed computer which implement the method are also disclosed.

### CROSS-REFERENCE TO RELATED APPLICATIONS

Benefit of provisional application Ser. No. 60/686,146 filed Jun. 1, 2006, is claimed.

### BACKGROUND OF THE INVENTION

Accuracy in the completion of documents is critical in many circumstances. While quality assurance measures have been enacted to make sure that machines are working accurately in manufacturing processes, and that humans perform accurately in repetitive processes, and that objective measures are recorded accurately by double checking that what you recorded was what you meant, answers which are somewhat subjective are more difficult to verify and collect accurately.

As a result there continues to be human error, and the more people involved in the process, the more the chance for error. People often mean to say or record one item in a series of choices but end up recording or saying another. This can be due to being distracted, rushing, not considering all of the choices available, confusion, guessing, and not taking the time to think things through.

For forms that record purely objective and factual data, computers now ask you to record your name and or e-mail address twice to confirm that you have written it correctly, or summarize a transaction at its conclusion. That repetition of the exact same information is one form of quality assurance. While a quality assurance measure in psychological tests is to ask a question twice, perhaps in a slightly different way, to confirm whether or not someone is being truthful by seeing if the two or more answers are consistent, this method of repeating a question in a number of slightly different ways has not been used to help improve accuracy and to determine what the correct answer really is to questions that can be accurately measured if enough time is given to completing a questionnaire.

The pharmaceutical industry uses rating scales in measures of depression, anxiety, and other symptoms to measure the efficacy of medication over time. Trained raters administer these rating scales. Many studies fail to document that medications are better than taking nothing at all. It is felt that one source of error that results in the inability of rating scales to accurately capture the true benefit of medication is the way that tests are administered, and, to counter this problem, significant monies are spent training professional to use the rating instruments more accurately. Suggestions for raters, among others, include making sure that raters ask all of the appropriate questions, and telling raters to take their time completing the entire test. While quality assurance measures to ensure that record entire interviews to critique raters, have a rater record on a document the amount of time that it takes to do an interview, compare the answers that a patient gives on one scale to the answers the patient gives to a rater at another time, quality is still lacking in the completion of rating documents. It is frequently suggested that raters slow down to improve accuracy and that they double check answers to improve answers, yet universally these suggestions are ignored. There has been no simple and verifiable way in this art to ensure that raters follow instructions regarding quality assurance and accuracy.

Psychological testing often has a set of instructions to be read to a subject prior to testing. When rushed for time, these statements may be paraphrased with the result that accuracy is sacrificed for speed.

Psychological testing and rating instruments are most frequently used to measure scores in total. There has been no good way to record the individual items of each test so that statistical measures can be easily applied to the individual items. The standard method in this art is to record the total score and the individual scores manually, and then for a data entry person to enter the scores at a later date so that statistical information can be gathered. Manual entry of the information is prone to human error, resulting in inaccurate data.

Timing a test on a computer is one way to assure that the time administering the test is within the accepted norms for maximum accuracy. For instance, it has been documented that it takes a certain period of time to take the Hamilton Rating Scale for Depression to obtain accuracy, however there has been no method to assure that the time that is necessary for the accurate completion of that document is being taken. Yet a quality assurance procedure that only records when someone begins and ends a test can not assure that someone has spent time individually on each test to complete the items.

In clinical research studies, the computerized use of scales gives immediate feedback that the total score on a test, i.e., the HAM-A, HAM-D, MRRS-D and the MADRS, is in the correct range i.e., above or below a certain threshold, for a subject to be included in a clinical research study. Paper and pen scores could be added wrong and a subject can be incorrectly included into a study. Or, if the scores are added correctly, the inclusion and exclusion criteria for a study could be incorrectly observed so that a patient can be entered into a study and be participating in a study for a lengthy period of time before the error is detected and it is realized that the recorded score was accurate, but that score should have disallowed that patient from entering in to the study.

Forced Confirmation was applied to the The McManus-Rosenberg Rating Scale for Depression, Self-Report Version (MRRS-D-SR), a new scale that was developed to fill the void in the clinical research industry for a self-rated depression scale. It objectively assesses all of the symptoms of Major Depressive Episodes, and assesses change in symptoms over the last 3 days, thereby reducing the error that cognitive dysfunction contributes to the rating of depressed individuals. Several versions of the MRRS-D-SR have been developed to address different clinical and research needs.

Error can come from both the test administrator and the test taker. Test taker error can be the result of confusion in general on the part of the test taker, the confusion that occurs as a result of the anxiety from taking a test, the confusion that results from the anxiety of being hurried while taking a test, or the confusion that results from depression or other illness that causes the subject to be confused. All of these need to be corrected so that answers are accurately recorded. A procedure that assured that enough time was being taken with each item of a test would improve accuracy. A procedure that double checked answers in a timely manner with the opportunity to correct answers after the correct response was elicited would improve accuracy.

Psychological testing and rating instruments are most frequently used to measure scores in total. There has been no good way to record the individual items of each test so that statistical measures can be easily applied to the individual items. The standard method in this art is to record the total score and the individual scores manually, and then for a data entry person to enter the scores at a later date so that statistical information can be gathered.

A method to ensure that raters take their time and verify answers is needed to ensure intra-rater reliability and inter-rater reliability, i.e., can a rater get the same results every time and can two raters get the same results with the same patient. These are two important measures of accuracy.

### SUMMARY OF THE INVENTION

The method of the invention provides quality assurance to the testing procedure by using a computer to give the questions and to record the answers and to both record the total amount of time it takes to give the test and to have the different parts of a test introduced at set time intervals on each item and to not allow the tester to move to the next item until a certain period of time has elapsed.

The method of the invention assures that when a symptom is measured according to the severity of its impairment, its intensity, or its frequency, that the rater will assure that if the subject answers that the severity is “x,” that the rater will have to ascertain that the severity of its impairment, its intensity, or its frequency is not “x+1,” and not “x−1” before moving on to the next question. Additionally, when the severity of the impairment, the intensity, or the frequency of y is “x,” the tester will have to make sure that the severity of the impairment, the intensity, or the frequency of “not y” is 100%−x before moving to the next field, etc. Patients who are confused about the question or the answer will be forced to improve the quality of their answers according to the invention. Raters will be sure what the subjects really mean when they are responding to questions.

The method of the invention comprises the recording and administration of rating scales in pharmaceutical research including, but not limited to, the HAM-D, the MADRS, the MRRS-D, the PANSS, and the HAM-A tests, on a computer that will allow individual item scores to be collected, will ensure that all introductory statements and all prompts suggested by the test designer or study designer are read, that the appropriate amount of time to take a test is taken, that all answers are verified, that data is permanent and not changeable once a test is completed, and that testing is in a format appropriate for statistical studies to be performed without the time wasted to data enter the already collected information.

The method and computer system of the invention ensure that the human rater administering a psychological test asks all of the alternative answers to a question to make sure that the answer that is initially given is the correct one. On a paper and pencil version of tests, the tester can bypass this step without anyone being aware. Forcing raters to ask every question and forcing self-raters to review every question before the next screen appears improves quality. The method of the invention requires that every rater examines every possible answer to every question by having a human rater or a test taker check off on each possible answer either yes or no, true or false, or present or absent for every alternative symptom or option before the next screen is available. This method which requires raters to answer confirmatory questions improves the quality of the data generated by the test method and system, which improves the results of the clinical trials being administered.

This method of having the information computerized and possibly wireless as well makes the information much more readily available to the pharmaceutical companies which sponsor the clinical research and brings added quality to research studies. The same process can be applied to the individual sub-scores or individual question scores of the HAM-A, HAM-D, MRRS-D and the MADRS. Frequently there are requirements for a certain score range and the immediate feedback of a scoring system that is based on a computerized scoring will prevent the wrong patients from being entered into a research trial.

The collected data can be examined and scored when using either a depression scale or an anxiety scale, for instance, to determine whether or not the answers are consistent with the diagnostic criteria for a major depressive episode or for the specific anxiety disorder being studied. Having the data in a form that is electronic provides portability to use the data in many ways that is not available at present when data is only collected with pen and paper. Data can be collected either on a desktop, laptop, a pocket personal computer or a PDA.

Confirming answers will make sure that human error on the part of the rater will not have resulted in the wrong answer being scored. Questions that are asking about a negative phenomenon, i.e. loss of sex drive in which the answer is that the drive is lost all of the time and the person has absolutely no interest in sex could inadvertently be scored a zero as a result of the rater thinking that since there is no sex drive a zero should be scored while instead a four should have been scored indicating that there is a severe loss of sex drive.

The McManus-Rosenberg Rating Scale for Depression, Self-Report Version (MRRS-D-SR) was developed to fill the void in the clinical research industry for a self-rated depression scale. Patients who use the electronic MRRS-D-SR-FC must do everything that professional raters do. With the FC version, raters can not proceed until they read all instructions, consider the complete question, and review all of the anchors for each question before selecting the best response. Additionally, the accuracy of their rating of each item is confirmed by forcing the self-rater to answer a second tier of questions. This forced-confirmation approach to testing holds the potential for more accurate ratings by preventing rushing, careless mistakes, transcription errors, and incomplete ratings. The FC technology can be applied to any scale and is compatible with electronic record keeping.

The MRRS-D-SR-FC was evaluated for construct validity and test-retest reliability, using a convenience sample of adult male and female subjects. Results were subjected to statistical analysis.

Construct validity was assessed in order to demonstrate that the MRRS-D-SR-FC is a valid measure of depressive symptoms. Correlations using raw scores derived from concurrent MRRS-D-SR-FC and BDI-II administrations were computed. The sample comprised 81 adult male and female subjects. The MRRS-D-SR-FC summed raw scores correlated 0.77 (p <0.001) with the BDI-II summed raw scores, supporting the construct validity of the MRRS-D-SR-FC.

Test-Retest Reliability. The MRRS-D-SR-FC was consecutively administered to 31 adult male and female subjects experiencing a Major Depressive Episode. The time between administrations was 2-3 weeks. The correlation between summed scores was 0.82 (p <0.001), demonstrating a significant positive relationship.

The following is an example of a set of screen instructions which embody the method of the invention and are implimented by the computer-readable instructions in a computer programmed to carry out the method.

The first screen displays instructions to the patient. At the bottom of the first screen is a timer that initially reads 10 seconds. Reading the instructions carefully to the subject requires at least 10 seconds; the rater cannot advance the screen until the 10 seconds have elapsed. This ensures that the rater doesn't skip this screen, paraphrase the instructions or just say to the patient, “Since you remember this test from last time, lets proceed.”

Once the screen is advanced the first question is presented. In this example the first question is about depressed mood. It reads as follows: “This question is about depressed mood. During the past three days have you experienced any of the following? Feeling sad; feeling gloomy; feeling empty; feeling depressed moods; crying or being tearful.” Next to each of these five different symptoms of depressed mood is a “yes” and a “no” button. Every one of these questions needs to be answered either “yes” or “no” before the screen can advance. To provide quality assurance and to make sure that some thought is given to answering the questions, 15 seconds needs to elapse before the screen can advance, too.

When “next” is pressed, if any of these symptoms have elicited a “yes” response, i.e. the subject agrees to having one or more of these five symptoms of depressed mood, the next screen, while keeping the answers from the previous screen visible, prompts with the question, “During the past three days how often have you experienced these symptoms,” and offers the following options: “rarely; some of the time; most of the time; all or almost all of the time.” Once one of these frequencies is endorsed, then the screen can be advanced.

If “some of the time” is the endorsed frequency, the next screen requires that the endorsed frequency be confirmed (forced confirmation) by asking the three confirmation questions as follows: “Did you have these feelings just rarely?”; “Did you have these feeling most of the time?”; “So at least half of the time you were not depressed?”Each of these confirmation questions is to be answered “yes” or “no” and all three of these need to be answered before screen can advance. If the first two are answered “no”, and the last is answered “yes”, the answers that the subject has confirmed are consistent with the original frequency endorsement and then screen will advance to the next question, as this subject has confirmed that they are depressed some of the time and not just rarely, depressed some of the time and not most of the time and depressed some of the time and not depressed half of the time or more, i.e., he or she is not depressed most of the time.

On the other hand, if the answers on the confirmation screen are not “yes, yes, and no” as above, the screen will not advance, but instead an alert box will appear that will alert the rater that the answers to the confirmation questions do not match the frequency on the previous screen and therefore do not confirm the endorsed frequency and that the rater needs to review the endorsed frequency response of symptoms for this item with the patient. Once the alert screen is acknowledged, the previous screen automatically appears, asking once again the question “During the past three days how often have you experienced these symptoms,” and offers the following options: “rarely, some of the time, most of the time, all or almost all of the time.” At that point the subject can either continue to endorse the same frequency and advance to the next screen or change the frequency and advance to the next screen. If the subject continues to endorse “some of the time,” the next screen requires that the endorsed frequency be confirmed by asking the three confirmation questions again as follows: “Did you have these feelings just rarely?”; “Did you have these feeling most of the time?”; “So at least half of the time you were not depressed?”If the first two are answered no, and the last is answered yes, the answers that the subject has given are consistent with the frequency response for this item and then screen will advance to the next question, as this subject has confirmed that they are depressed some of the time and not just rarely, depressed some of the time and not most of the time and depressed some of the time and not depressed half of the time or more, i.e., he or she is not depressed most of the time.

If instead, the subject now endorses “most of the time,” as the frequency in response to the question “During the past three days how often have you experienced these symptoms,” then the next screen requires that the endorsed frequency be confirmed with a different set of confirmation questions than those that confirm a “some of the time response,” by asking the confirmation questions as follows: “Did you have these feelings less than half of the time?”“Did you have these feeling all or almost all of the time?”; “So less than half of the time you were not depressed?”If the first two are answered “no”, and the last is answered “yes”, the answers that the subject has given are consistent and then screen will advance to the next question, as this subject has confirmed that they are depressed most of the time and not less than half of the time, depressed most of the time and but not all or almost all of the time and depressed most of the time and not depressed less than half of the time, i.e., he or she is not depressed some of the time.

When there continues to be a discrepancy, with a rater asking the questions, the rater will eventually clarify and get a consistent answer from the subject. When using forced confirmation with a self-rated scale, after three fails to confirm, the program will advance itself to the next question, and the frequency will be scored as an average between the disparate endorsed frequencies.

If no symptoms are endorsed on the first screen, i.e. all of the questions in “This question is about depressed mood. During the past three days have you experienced any of the following? Feeling sad; feeling gloomy; feeling empty; feeling depressed moods; crying or being tearful.” are answered “no,” then the next screen will ask, “so you haven't felt depressed even a little?”and one or the other of the boxes “No, not even a little,” or “Maybe a little” needs to be endorsed. If “Maybe a little” is endorsed, the rater is alerted with an error box and returned to the original frequency question to again see if any of the symptoms are present at all. If “No, not even a little,” is endorsed, the question “So all of the time you were not depressed,” is asked and the answers “Yes, that is true” and “No that is false” appear. If “Yes that is true is endorsed,” the rater is advanced to the next question as the answer that the symptoms are not present at all has been confirmed. If the answer “No that is false” is endorsed, the rater is alerted with an error box and when that alert is acknowledged, the rater is returned to the original frequency question regarding the five symptoms of depressed mood to again see if any of the symptoms are present at all. This sequence is repeated until the frequency of symptoms is confirmed. As noted above, with a rater asking the questions, the rater will eventually clarify and get a consistent answer from the subject. When using forced confirmation with a self-rated scale, after three fails to confirm, the program will advance itself to the next question, and the frequency will be scored as an average between the disparate endorsed frequencies.

While the invention has been described and illustrated in detail herein, the invention is capable of being practiced in various alternative embodiments which should become apparent to those skilled in this art without departing from the spirit and scope of the invention.

What is claimed is:

1. A method of improving the accuracy of administration of a psychological test by human raters comprising providing a computer which is programmed to
A. display a first question on a screen;
B. receive an answer to the first question from a human rater;
C. display a confirmation question on the screen;
D. receiving an answer to the confirmation question from the human rater;
E. comparing the answer, D, to a correct answer to the confirmation question;
F. if the answer to the confirmation question matches the correct answer, then displaying a next question on the screen;
G. if the answer to the confirmation question does not match the correct answer, then redisplaying the first question.

2. The method of claim 1 further including delaying display of a subsequent question for a predetermined amount of time in order to allow sufficient time for the human rater to view the question.

3. The method of claim 1 further including tracking the total time spent on each question and confirmation question and total time spent on the entire test.

4. A set of instructions recorded in a computer readable medium for assisting in the administration of a psychological test by human raters comprising means to
A. display a first question on a screen;
B. receive an answer to the first question from a human rater;
C. display a confirmation question on the screen;
D. receive an answer to the confirmation question;
E. compare the answer to the confirmation to a correct answer;
F. if the answer to the confirmation question is correct, then displaying a next question on the screen;
G. if the answer to the confirmation question matches the correct answer, then display a next question on the screen;
H. if the answer to the confirmation question does not match the correct answer, then redisplay the first question.

5. A method for improving the accuracy of administration of a psychological test by a human rater comprising providing a computer which is programmed to ask a test question, receive an answer from the human rater, and not go on to ask the next question unless until the rater accurately answers a confirmation question which is designed to insure that the answer to the last question was correct.

6. A computer programmed to implement the method of claim 4.

7. A set of computer-readable instructions adapted to carry out the method of claim 4 on a computer having a display.
